(19) United States
(12) Patent Application Publication
(10) Pub. No.: US 2010/0009687 A1
(43) Pub. Date: Jan. 14, 2010

(54) SYSTEM AND METHOD FOR ENABLING EFFICIENT MBMS DOWNLINK RADIO RESOURCE RE-USE FOR OTHER DOWNLINK TRAFFIC

(75) Inventors: Tommi Tapani Koivisto, Espoo (FI); Henri Markus Koskinen, Espoo (FI); Lars Dalsgaard, Oulu (FI); Lars Erik Lindh, Helsingfors (FI); Mikko Juhana Rinne, Espoo (FI)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/430,500

(22) Filed: Apr. 27, 2009

Related U.S. Application Data
(60) Provisional application No. 61/048,541, filed on Apr. 28, 2008.

(51) Int. Cl. H04W 72/00

(52) U.S. Cl. 455/450

(57) ABSTRACT

A system and method by which individual user equipment items can be informed about subframes re-used or exceptionally used for unicast transmission. In various embodiments, a dedicated indication is transmitted to each item of user equipment. This indication may comprise, for example, a dedicated message transmitted to those user equipment items that will get additional unicast downlink allocations in the re-used subframes. In other embodiments, common broadcast signaling is used to indicate subframe re-use to all items of user equipment. This signaling may be transmitted on a physical downlink control channel (PDCCH) or on a physical downlink shared channel (PDSCH) as a common broadcast message.

### RELATED APPLICATION

This application claims priority to U.S. Provisional Application No. 61/048,541 filed Apr. 28, 2008, which is hereby incorporated by reference in its entirety.

### FIELD OF THE INVENTION

The present invention relates generally to Multimedia Broadcast/Multicast Services (MBMS). More particularly, the present invention relates to the signaling and processing of information in an MBMS Single Frequency Network (SFN) environment.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The 3^{rd} Generation Partnership Project (3GPP) has defined MBMS for the simultaneous delivery of multimedia content to a large set of receivers. A set of MBMS specifications have been published by 3GPP, covering all aspects of the service from the radio access to the content delivery applications and protocols. As part of 3G long term evolution (LTE), MBMS is being standardized for the purpose of supporting efficient broadcast services such as, for example, mobile TV services.

LTE MBMS currently supports two transmission modes—a single-cell, point-to-multipoint transmission mode and a MBMS over a single frequency network (MBSFN) transmission mode. In MBSFN, each base station transmits the same content in a synchronized manner. Operating in this manner, MBSFN enables a highly efficient method of broadcasting, as the transmissions from different base stations reinforce each other instead of causing interference with each other.

LTE MBMS can be deployed on a carrier dedicated to MBMS. Alternatively, LTE MBMS can share a carrier with LTE unicast transmissions. In the case where LTE MBMS shares a carrier with LTE unicast transmissions, the MBSFN transmissions are time-multiplexed with unicast transmissions. The radio resources used for MBSFN may be semi-statically pre-reserved by a central network entity, or operation and maintenance entity. Information on time slots, e.g., subframes, reserved for MBSFN is signaled to user equipments.

### SUMMARY

According to one aspect of the present invention, a method for enabling the re-use of MBSFN subframes, for example for unicast transmission, and the signaling of information associated with re-used MBSFN subframes to user equipments, is provided. In various embodiments, a dedicated indication is transmitted to each item of user equipment. This indication may comprise, for example, a dedicated message transmitted to those user equipment items that will get additional unicast downlink allocations in the re-used subframes. The message, at its simplest, may involve only a single bit indicating that the user equipment should check the next MBSFN subframe(s) for possible downlink allocations. In other embodiments, common broadcast signaling is used to indicate subframe re-use to all items of user equipment. This signaling may be transmitted on a physical downlink control channel (PDCCH) or on a physical downlink shared channel (PDSCH) as a common broadcast message. The signaling may indicate which MBSFN subframes are re-used within a certain period, e.g., in current radio frame in various embodiments.

Various embodiments provide for methods, computer program products and apparatus for informing user equipment items about the re-use of MBSFN subframes. According to various embodiments, an indication is prepared for transmission to a network. The indication indicates that at least one subframe in a radio frame is being exceptionally used for unicast transmission “Exceptionally used” refers to the concept that certain subframes which are reserved for MBSFN transmissions are re-used for unicast transmissions instead. The radio frame may include the indication. The indication and the radio frame are then transmitted to the network.

Various embodiments also provide for methods, computer program products and apparatus for processing information about the re-use of MBSFN subframes. According to various embodiments, an indication is received from a transmitting device. The indication indicates that at least one subframe in a radio frame is being exceptionally used for unicast transmission. The at least one subframe is processed by a user equipment item in accordance with the received indication.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1(a) is a block diagram of an example MBMS architecture within which various embodiments of the present invention may be implemented;

FIG. 1(b) is a block diagram of another example MBMS architecture within which various embodiments of the present invention may be implemented;

FIG. 2 is a bar graph showing an example variable bit rate of a video bitstream associated with an example video codec used in LTE MBMS;

FIG. 3 illustrates the signaling of re-used MBSFN subframes to at least one user equipment according to an example embodiment of the present invention.

FIG. 4 illustrates the signaling of re-used MBSFN subframes to at least one user equipment according to another example embodiment of the present invention

FIG. 5 is a perspective view of an electronic device that can be used in conjunction with the implementation of various embodiments of the present invention; and

FIG. 6 is a schematic representation of the circuitry which may be included in the electronic device of FIG. 5.

### DETAILED DESCRIPTION OF VARIOUS EMBODIMENTS

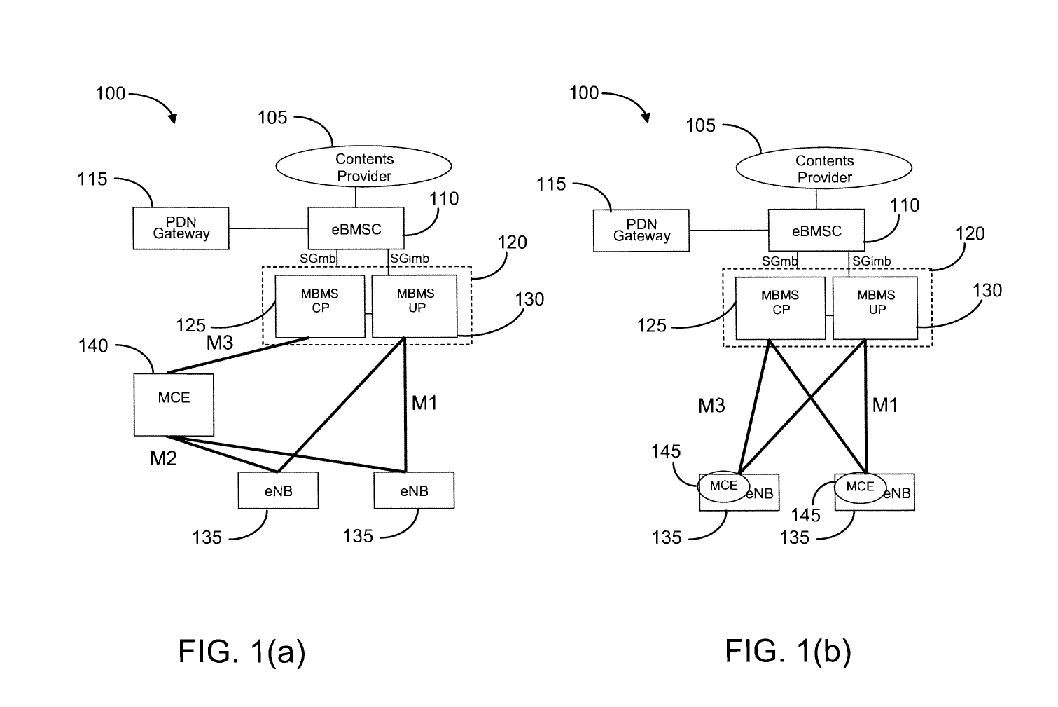

FIG. 1(a) is a block diagram of an example MBMS architecture 100 within with various embodiments of the present invention may be implemented. As shown in FIG. 1(a) a contents provider 105 communicates with an Evolved Universal Terrestrial Radio Access Network (E-UTRAN) broadcast multicast service center 110. The E-UTRAN broadcast multicast service center 110 communicates with both a packet data network (PDN) gateway 115 and an E-UTRAN MBMS gateway 120. The E-UTRAN MBMS gateway includes a MBMS control point 125 and a MBMS user-plane 130. In the embodiment shown in FIG. 1(a), the MBMS user-plane 130 communicates with one or more E-UTRAN node B's (eNB) 135 through a communication interface M1. The MBMS control point communicates with a multicell/multicast coordination entity (MCE) 140 through a communication interface M3. The multicell/multicast coordination entity (MCE) 140 interacts with eNBs 135 via a communication interface M2.

FIG. 1(b) is a block diagram of another example MBMS architecture 100 within which various embodiments of the present invention may be implemented. The MBMS architecture of FIG. 1(b) is similar to that of FIG. 1(a) except that in the architecture of FIG. 1(b) each eNB 135 includes its own MCE 145. In FIG. 1(b) there is no M2 interface and the MBMS control point communicates with each multicell/multicast coordination entity (MCE) 140, within each eNB 135, through a communication interface M3.

An example use case of LTE MBMS is mobile TV. The bit rate of a typical video codec used in LTE MBMS, e.g., H.264, defined by the International Telecommunications Union (ITU), may be highly variable. Due to the variability of the bit rate(s) of video bitstream(s), network resources may be allocated so that to accommodate all expected bit rates, for example based on a maximum bit rate.

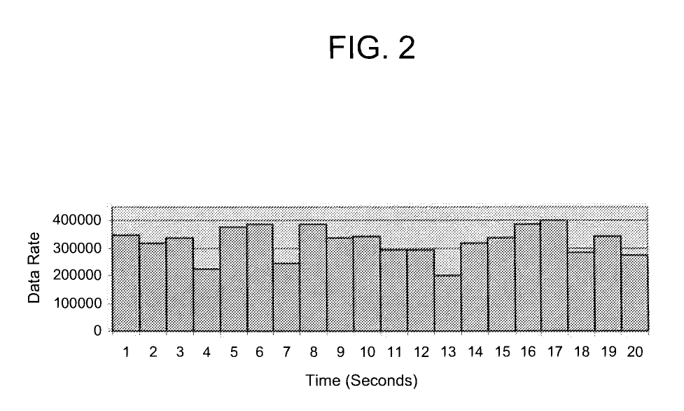

FIG. 2 is a bar graph showing an example variable bit rate of a video bitstream associated with an example video codec used in LTE MBMS. FIG. 2 shows a bit rate averaged over one second intervals. In an example embodiment, one second may be the longest possible buffering interval allowed by existing channel-change time requirements. A shorter averaging interval may result in even greater bit rate variability. The example bit rate illustrated in FIG. 2 varies between 200 kilobits per second (kbps) and 400 kbps.

In an example embodiment, radio resources allocated for such a service may be based on a maximum bit rate of the service in order to avoid data losses. In such a case, some of the radio resources may be left unused, for example when the actual bit rate at some period of time is smaller than the maximum bit rate. For example, assuming a typically required 1 bps/Hz spectral efficiency in MBSFN transmissions, the amount of data that can be transmitted in a single subframe on a typical carrier is on the order of about 10 kilo bits. In the context of FIG. 2, this means that the number of subframes required to transmit one second of the example video stream may vary between 20 and 40 subframes. Assuming that, for example, 40 subframes are allocated for MBSFN transmission, a significant number of subframes may be wasted, e.g. not used, when the bit rate is smaller than 400 kbps for example. A more efficient use of radio resources takes into account the variability of bit rates of one or more services within each scheduling interval.

One method of addressing this issue involves bundling multiple services into a service multiplex and having the radio resource allocation performed for the whole multiplex. In this arrangement, the multiplexing may stabilize relative bit rate variations, for example between different bitstreams. However, if the bit rates of different bitstreams vary in the same way, for example a simultaneous decrease or simultaneous increase for all bit rates, the multiplexing in this case may not help in terms of efficient use of radio resources. Therefore, radio resources semi-statically reserved for MBSFN may still be left unused during some periods of time.

In an example embodiment, in order to utilize the spectrum as effectively as possible, the radio resources left unused may be “re-used” for some other transmissions. In the LTE MBMS context, this involves re-using the time slots, or subframes, allocated for MBSFN transmissions for, for example, LTE unicast downlink purposes whenever possible. However, issues may arise because the user equipments do not have, in this case, the knowledge about re-used subframes. Therefore, the user equipments will not be aware of any downlink allocations in these subframes. User equipments may potentially ignore re-used MBSFN subframes because they are not expecting to receive any downlink unicast data in these subframes.

In LTE MBMS, services may be scheduled in periods of length of one tenth of a second to one second, with the likely lengths being in the range of 320 milliseconds to 640 milliseconds. These periods of time are referred to herein as scheduling periods. The allocation of MBSFN subframes is signaled in system information. In an example embodiment, the allocation is semi-static and may not be changed at this periodicity.

Systems and methods are provided by which individual user equipment items may be informed about re-used or exceptionally used subframes. “Exceptionally used” refers to the concept that certain subframes which are reserved for MBSFN transmissions are re-used, for example, for unicast transmissions instead. According to a first example embodiment, a dedicated indication is transmitted to one or more user equipments. This indication may comprise, for example, a dedicated message transmitted to those user equipments that will get additional unicast downlink allocations in the re-used subframes. In an example embodiment, the message is sent together with the downlink (DL) allocation preceding the re-used MBSFN subframes. The message, at its simplest, may involve only a single bit indicating to a user equipment to check the next MBSFN subframe(s) for possible downlink allocations.

The first example embodiment discussed above may be implemented using various mechanisms. For example, a field may be included in a PDCCH message in order to indicate, with a specified value, that the next MBSFN subframe may contain additional downlink allocations for the addressed user equipment. Alternatively, the field may be used to indicate that any of the MBSFN subframes within the current radio frame may contain additional downlink allocations for the addressed user equipment. Because downlink grants in PDCCH are dedicated signaling, this information may be indicated only to the items of user equipment that, e.g., have data in an evolved Node B (eNB) buffer and may be scheduled in the re-used subframes.

In another implementation, the indication may be provided together with the downlink data in PDSCH. For example, the indication may be provided in the medium access control (MAC) headers or as a dedicated MAC control element. In the case where the indication is provided as a dedicated MAC control element, there is no implied constant added signalling cost. There is also no implied constant added signalling cost when the indication is provided in the MAC headers if the indication is signaled using one of the header bits currently designated as reserved; there are currently two reserved bits in the MAC header for the downlink shared channel (DL-SCH).

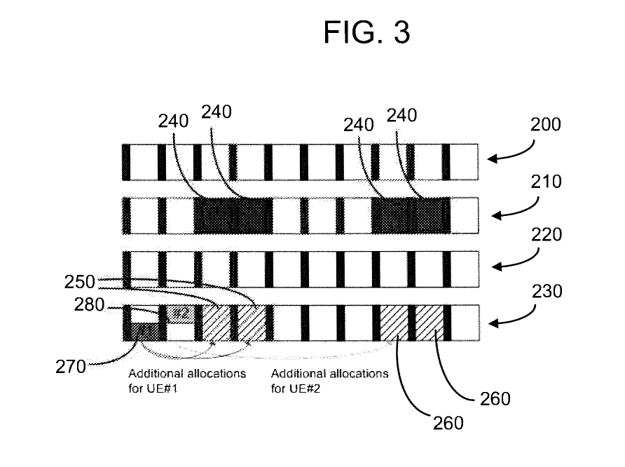

FIG. 3 illustrates the signaling of re-used MBSFN subframes to at least one user equipment according to an example embodiment of the present invention. In this embodiment an indication about possible additional downlink allocations in subsequent subframes is attached to a preceding downlink unicast allocation associated with the user equipment(s) that will be the destination(s) of the re-used subframes. FIG. 3 shows first, second, third and fourth radio frame 200, 210, 220 and 230, respectively. As shown in FIG. 3, the second radio frame 210 includes a plurality of MBSFN subframes 240. The fourth radio frame 230 includes a first set of re-used subframes 250 for a first user equipment, and a second set of re-used subframes 260 for a second user equipment. The other subframes depicted in FIG. 3 are unicast subframes. The fourth radio frame 230 also includes first and second indications 270 and 280. The first indication 270 provides information about a possible additional downlink allocation in the subsequent subframes for use by the first user equipment, and the second indication 280 provides information about a possible additional downlink allocation in the subsequent subframes for use by the second user equipment. When a first user equipment and a second user equipment receive, respectively, a first indication and a second indication, they tune their receivers to receive unicast data in indicated, or signaled, re-used subframes. The received data, may be processed by receiving user equipments.

In the first embodiment, neither the reading of the signaling message nor the receiving of a re-used subframe may require additional wake-ups from the user equipment(s), as opposed to extending individual wake-up periods. Instead, the signaling message informs user equipments during their normal wake-up time to extend their monitoring of PDCCH to certain subframes that are normally used for MBSFN. Therefore, signaling a re-used subframe, according to an example embodiment, takes place as shortly as possible prior to the re-used subframe. In one particular embodiment, in a radio frame where subframes are re-used for downlink unicast traffic, the exact re-used subframes are signaled in the last unicast subframe before the first MBSFN subframe as indicated in the default allocation given in system information. It should be noted that the eNB may know which user equipment(s) will be awake and monitor the signaling message. Therefore, in an example embodiment, the eNB knows which items of user equipment may be scheduled in the re-used subframes.

In a second embodiment, common broadcast signaling is used to indicate subframe re-use to all user equipments. This signaling may be transmitted on PDCCH or on PDSCH as a common broadcast message. Furthermore, in order to save radio resources and avoid unnecessary decoding at the terminal, the signaling may be transmitted only, for example, in those radio frames that contain re-used MBSFN subframes. This message may indicate which MBSFN subframes are re-used within a certain period, such as in a current radio frame.

The second embodiment may be implemented via the adding of a special broadcast PDCCH format or broadcast message on PDSCH to indicate which MBSFN subframes have been re-used. This message may be transmitted at least once per scheduling period, since the re-used subframes vary from scheduling period to scheduling period. However, the message may be transmitted more than once per scheduling period in various embodiments. For example, the special broadcast PDCCH format may be transmitted only in the radio frames that contain re-used MBSFN subframes, in a known place such as subframe #0 or, in order to minimize the distance to the re-used subframes, the last subframe before the first subframe indicated as MBSFN in system information. As each terminal or user equipment knows which radio frames may contain MBSFN subframes, based on system information, the terminals would then check for the PDCCH message only in those radio frames. Furthermore, the terminals may perform this check only in the event that they are not in discontinuous reception (DRX), which means also that only such terminals may be scheduled in the re-used subframes. As the size of the broadcast PDCCH message may be rather short, the message may easily be matched to the existing PDCCH formats in order to not increase the number of blind decoding attempts at the terminal.

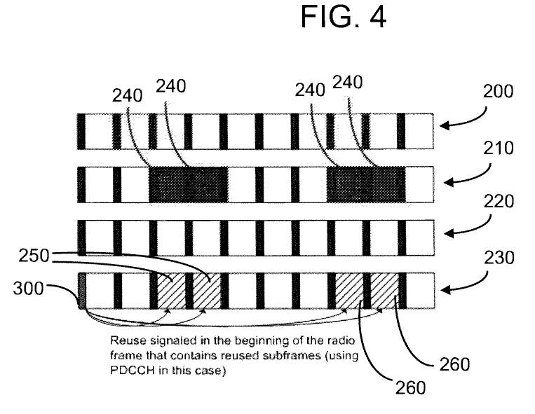

FIG. 4 illustrates the signaling of re-used MBSFN subframes to at least one user equipment according to another example embodiment of the present invention. In this embodiment a common signaling may be used for user equipments, indicating which MBSFN subframes are re-used within a certain period for unicast transmission. As in the case of FIG. 3, FIG. 4 shows first, second, third and fourth radio frame 200, 210, 220 and 230, respectively. The second radio frame 210 includes a plurality of MBSFN subframes 240. The fourth radio frame 230 includes a first set of re-used subframes 250 for a first item of user equipment and a second set of re-used subframes 260 for a second item of user equipment. The other subframes depicted in FIG. 4 are unicast subframes. In contrast to the arrangement depicted in FIG. 3, however, a signaling 300 is provided at the beginning of the fourth radio frame 230, indicating that this radio frame includes re-used subframes. As mentioned above, the signaling 300 is common to all of the user equipments. In this instance, a PDCCH message is used for the common signaling 300.

In an embodiment where the indication, or signaling, of re-used subframes is broadcast to all user equipments, user equipments read the indication, or signaling, to find out which MBSFN subframes are re-used for unicast transmission. User equipments, may then check the indicated MBSFN subframes for data sent to them. User equipment for whom unicast data was sent in re-used MBSFN subframes may receive the unicast data and process it. Unicast data in re-used subframes may comprise user equipment identities corresponding to user equipment receiving the unicast data.

In another example embodiment, the re-used MBSFN subframes, as well as the user equipments receiving unicast data in the re-used MBSFN subframes, may be indicated in the broadcast message. In this case, only user equipment indicated in the broadcast message tune their receivers to the indicated subframes.

The following describes how eNB's determine which subframes reserved for MBSFN can be re-used for unicast transmission. The MBMS user-plane entity in the core network uses a SYNC protocol to provide sufficient information to the eNBs to permit the eNBs to determine independently, but still in a unique and uniform manner, which service data from the MBMS user-plane entity is to be transmitted in which subframes reserved for this particular multicast channel.

The subframes reserved for a multicast channel must be decided centrally by a multicell coordination entity (MCE), and this information needs to be signaled to the eNBs. Therefore, the decisions are made beforehand in a semi-static way, e.g., the allocation may not instantly and accurately adapt to the varying bit rate generated by the service(s) to be transmitted. On the other hand and as discussed previously, the data rates of services vary significantly. For this reason, subframes for a multicast channel are overbooked, e.g., there are subframes reserved for the multicast channel but left unused by the MBSFN transmission because of varying service data rates. With the SYNC-protocol, the eNBs know within which subframes to transmit the service data. Therefore, the eNBs also know which subframes are reserved for a multicast channel but are not used for the particular MBSFN transmission. These subframes may be re-used for unicast transmission.

In terms of the scheduling of user equipment items in the re-used subframes, the scheduling does not have to be particularly specified or standardized in various embodiments. Instead, the scheduling may be up to the scheduler in the eNB and may depend on, for example, the downlink-buffer status of the different user equipment items' ongoing connections. In certain embodiments, connections carrying elastic traffic such as download information are scheduled instead of Voice over IP (VoIP), as VoIP will require separate capacity reservation, in addition to the multicast channels. In another embodiment, items of user equipment are scheduled whose channel feedback indicates that they happen to have good radio conditions during and/or around the re-used subframes. This permits the system to make more efficient use of the re-used subframes.

Various embodiments discussed herein enable MBSFN subframe re-use for unicast purposes. The signalling is sufficiently dynamic to cope with changes in the number of unused subframes within scheduling periods. This is in contrast to system information signalling, which is not sufficiently dynamic to achieve this purpose. The signalling of various embodiments discussed herein also fits seamlessly into the existing physical-layer solution and does not require any fundamental changes or additional structures. The signaling also has a small impact on user equipment scheduling rules. Items of user equipment not actively receiving MBMS will not have to monitor MBSFN solely for issues of re-use, thereby minimizing unnecessary user equipment activity and saving battery power. At the same time, by being able to flexibly assign subframes to items of user equipment who are already actively scheduled, the re-use of sub-frames is enabled.

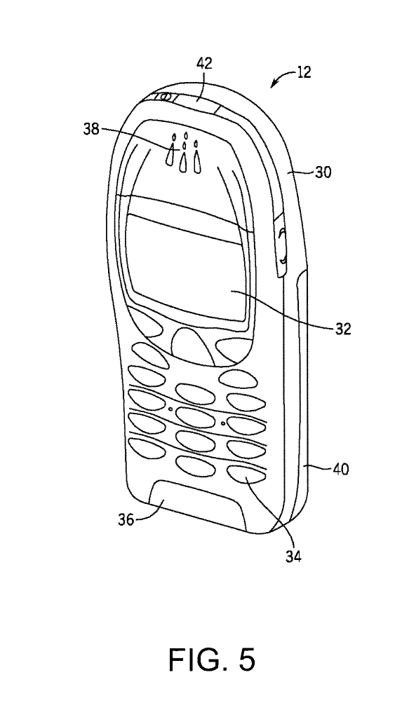

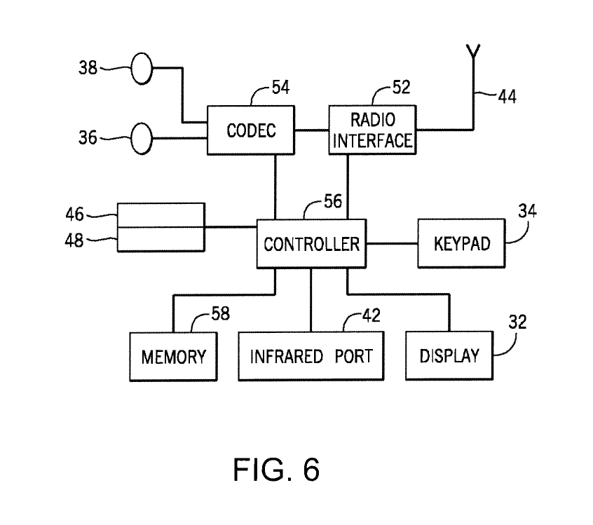

FIGS. 5 and 6 show one representative mobile device 12 within which various embodiments may be implemented. Any and all of the devices described herein may include any and/or all of the features described in FIGS. 5 and 6. It should be understood, however, that the present invention is not intended to be limited to one particular type of electronic device. The mobile device 12 of FIGS. 6 and 7 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art.

Various embodiments provide for a method, comprising preparing an indication for transmission to a network, the indication indicating that at least one subframe in a radio frame is being exceptionally used for unicast transmission; and transmitting the indication and the radio frame to the network.

Various embodiments provide for a computer program product, embodied in a computer-readable storage medium, comprising computer code configured to prepare an indication for transmission to a network, the indication indicating that at least one subframe in a radio frame is being exceptionally used for unicast transmission; and computer code configured to transmit the indication and the radio frame to the network.

Various embodiments provide for an apparatus, comprising a transmitting device configured to prepare an indication for transmission to a network, the indication indicating that at least one subframe in a radio frame is being exceptionally used for unicast transmission; and transmit the indication and the radio frame to the network.

Various embodiments provide for an apparatus, comprising means for preparing an indication for transmission to a network, the indication indicating that at least one subframe in a radio frame is being exceptionally used for unicast transmission; and means for transmitting the indication and the radio frame to the network.

Various embodiments provide for a method, comprising receiving an indication from a transmitting device, the indication indicating that at least one subframe in a radio frame is being exceptionally used for unicast transmission; and at least selectively processing the at least one subframe in accordance with the received indication.

Various embodiments provide for a computer program product, embodied in a computer-readable storage medium, comprising computer code configured to process a received indication from a transmitting device, the indication indicating that at least one subframe in a radio frame is being exceptionally used for unicast transmission; and computer code configured to at least selectively process the at least one subframe in accordance with the received indication.

Various embodiments provide for an apparatus, comprising a user equipment item configured to receive an indication from a transmitting device, the indication indicating that at least one subframe in a radio frame is being exceptionally used for unicast transmission; and at least selectively process the at least one subframe in accordance with the received indication.

Various embodiments provide for an apparatus, comprising means for receiving an indication from a transmitting device, the indication indicating that at least one subframe in a radio frame is being exceptionally used for unicast transmission; and means for at least selectively processing the at least one subframe in accordance with the received indication.

According to various embodiments, the indication may be dedicated to at least one user equipment item. The indication may comprise a message which is transmitted to each user equipment item that is to receive additional unicast downlink allocations in at least one subframe of the radio frame. The indication may comprise a single bit, the single bit indicating that the at least one user equipment item should check subsequent subframes for possible downlink allocations. The indication may be included with a downlink allocation preceding the at least one subframe that is being exceptionally used for unicast transmission. The indication may be transmitted on a physical downlink control channel. The indication may be included within a medium access control protocol header. The indication may comprise a dedicated medium access control protocol element. The indication may be included within common broadcast signaling for reception by all active user equipment items within the network. The indication may not be prepared if the radio frame does not include exceptionally used subframes. The indication may further indicate which subframes are being used within a predefined period, and the predefined period may comprise the radio frame. The indication may be included within the radio frame.

The various embodiments described herein are described in the general context of method steps or processes, which may be implemented in one embodiment by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software implementations of various embodiments can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

Embodiments of the present invention may be implemented in software, hardware, application logic or a combination of software, hardware and application logic. The software, application logic and/or hardware may reside on a chipset, a mobile device, a desktop, a laptop or a server. The application logic, software or an instruction set is preferably maintained on any one of various conventional computer-readable media. In the context of this document, a “computer-readable medium” can be any media or means that can contain, store, communicate, propagate or transport the instructions for use by or in connection with an instruction execution system, apparatus, or device.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
preparing an indication for transmission to a network, the indication indicating that at least one subframe in a radio frame is being exceptionally used for unicast transmission; and
transmitting the indication and the radio frame to the network.

2. The method of claim 1, wherein the indication is dedicated to at least one user equipment item.

3. The method of claim 2, wherein the indication comprises one or more of the following:
a message which is transmitted to each user equipment item that is to receive additional unicast downlink allocations in at least one subframe of the radio frame;
a single bit indicating that the at least one user equipment item should check subsequent subframes for possible downlink allocations; and
a dedicated medium access control protocol control element.

4. The method of claim 2, wherein the indication is included with a downlink allocation preceding the at least one subframe that is being exceptionally used for unicast transmission.

5. The method of claim 2, wherein the indication is transmitted on a physical downlink control channel.

6. The method of claim 2, wherein the indication is included within a medium access control protocol header.

7. The method of claim 1, wherein the indication is included within common broadcast signaling for reception by all active user equipment items within the network.

8. The method of claim 7, wherein the indication is transmitted on a physical downlink control channel.

9. The method of claim 7, wherein the indication is transmitted on a physical downlink shared channel.

10. The method of claim 7, wherein the indication is not prepared if the radio frame does not include exceptionally used subframes.

11. The method of claim 7, wherein the indication further indicates which subframes are being used within a predefined period.

12. The method of claim 11, wherein the predefined period comprises the radio frame.

13. The method of claim 1, wherein the indication is included within the radio frame.

14. A computer program product, embodied in a computer-readable storage medium, comprising computer code configured to perform the processes of claim 1.

15. An apparatus, comprising:
a transmitting device configured to:
prepare an indication for transmission to a network, the indication indicating that at least one subframe in a radio frame is being exceptionally used for unicast transmission; and
transmit the indication and the radio frame to the network.

16. The apparatus of claim 15, wherein the indication is dedicated to at least one user equipment item.

17. The apparatus of claim 16, wherein the indication comprises one or more of the following
a message which is transmitted to each user equipment item that is to receive additional unicast downlink allocations in at least one subframe of the radio frame;
a single bit indicating that the at least one user equipment item should check subsequent subframes for possible downlink allocations; and
a dedicated medium access control protocol control element.

18. The apparatus of claim 16, wherein the indication is included with a downlink allocation preceding the at least one subframe that is being exceptionally used for unicast transmission.

19. The apparatus of claim 16, wherein the indication is transmitted on a physical downlink control channel.

20. The apparatus of claim 16, wherein the indication is included within a medium access control protocol header.

21. The apparatus of claim 15, wherein the indication is included within common broadcast signaling for reception by all active user equipment items within the network.

22. A method, comprising:
receiving an indication from a transmitting device, the indication indicating that at least one subframe in a radio frame is being exceptionally used for unicast transmission; and
at least selectively processing the at least one subframe in accordance with the received indication.

23. The method of claim 22, wherein the indication is dedicated to at least one user equipment item.

24. A computer program product, embodied in a computer-readable storage medium, comprising computer code configured to perform the processes of claim 22.

25. An apparatus, comprising:
a user equipment item configured to:
receive an indication from a transmitting device, the indication indicating that at least one subframe in a radio frame is being exceptionally used for unicast transmission; and
at least selectively process the at least one subframe in accordance with the received indication.
